(19) United States
(12) Patent Application Publication
(10) Pub. No.: US 2008/0058148 A1
(43) Pub. Date: Mar. 6, 2008

(54) Wheel-And-Disc Drive

(75) Inventors: Horst Adel, Oberreichenbach (DE); Michael Bogner, Eckental (DE); Johann Singer, Grossenseebach (DE); Thomas Kraft, Neuhof/Zenn (DE); Diethard Sauermann, Bubenreuth (DE); Ralf Walter, Aachen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/573,382

(22) PCT Filed: Apr. 22, 2005
(86) PCT No.: PCT/EP05/04345

§ 371 Date: Feb. 7, 2007

(30) Foreign Application Priority Data
May 25, 2004 (DE) 102004025542.3

(51) Int. Cl. F16H 13/14; F16H 13/08

(52) U.S. Cl. 475/195

(57) ABSTRACT

A friction drive is provided, in particular for frictionally engaged driving of an auxiliary unit of an internal combustion engine, with an adjustable friction wheel (3), which can be brought into pressure contact with at least one contact disk (4, 6) of a drive element (5) and/or a driven element (7). A need-dependent drive of the auxiliary unit is achieved by a switchable coupling, which is used for need-dependent separation of the drive element (5) and auxiliary unit.

### BACKGROUND

The invention relates to a friction wheel drive for the frictionally engaged driving of units of an internal combustion engine. For this purpose, the friction wheel drive is provided with an adjustable friction wheel, which can be pressed with a non-positive fit against at least one contact disk of a drive and driven element.

Alternatively, a friction wheel drive with an adjustable friction wheel is presented, which can be pressed against the contact disk of a drive element and which has a self-propulsion unit.

From DE 196 35 808 A1, a friction wheel drive of the type noted above is known. This publication relates to a friction wheel drive designed for a vehicle. It is used to assist the conventional drive of the vehicle when needed through an auxiliary drive for the vehicle wheels that are normally not driven.

The friction wheel drive includes an electric motor, which, via a transmission, drives a friction wheel that is adjustable in the direction of the wheel rim when needed. The wheels driven electrically by means of the friction wheel drive assist the conventionally driven wheels when there is too little static friction, which can occur, for example, when there is clear ice or when the conventional drive supplies too little power, e.g., on inclines that are too steep.

A disadvantage in the friction wheel drive described above is that a large number of auxiliary components are necessary due to its standalone drive, which increases the likelihood of faults and also the necessary installation space and the weight of the system.

### SUMMARY

The invention is based on the objective of providing a friction wheel drive, which enables minimal axial installation space and reliable driving of an auxiliary unit of the internal combustion engine depending on needs.

The objective is met according to the invention by the features of the independent claims 1 and 7. Other advantageous configurations of the invention are the subject matter of the dependent claims 2 to 6 and 8 to 12.

The invention according to claim 1 provides that the friction wheel is in sustained, frictionally engaged connection with the contact disks of a respective drive and driven element, at least when the internal combustion engine is running, by means of which the operation of an auxiliary unit is guaranteed during the operating period of the internal combustion engine.

The switchable coupling is used for separating the driven and drive elements of the auxiliary unit depending on need. If the auxiliary unit is a coolant pump, then this can be turned off, for example, in the startup phase of the internal combustion engine and thus can realize quicker heating. Reaching the operating temperature more quickly decisively influences the wear and the pollutant emissions of the internal combustion engine. Simultaneously, the drive power required when the internal combustion engine starts is reduced by the magnitude of the drive power of the coolant pump. Therefore, in this phase of the internal combustion engine, its fuel consumption decreases.

An advantageous improvement of the invention according to claim 1 provides that the switchable coupling is constructed as a friction-disk coupling. A friction-disk coupling is distinguished by simple construction, reliable function, and oil-free operation. Therefore, it is an economical component, which is suitable for a non-enclosed friction wheel drive.

In addition, the friction-disk coupling has the advantage of being able to be integrated into the installation space of the contact disk of the auxiliary unit, so that no additional spatial requirements are produced.

An actuator is advantageous, which is used for applying a contact pressure force to the friction wheel that is required for frictionally engaged transfer of the necessary power from the driven element to the drive element. For a friction wheel that has a rubber lining with an increased coefficient of friction, the smallest possible contact pressure force that can be achieved in this way reduces its wear and its flexing work.

A fixed measure of the slippage between the driven and the drive element is used as a measure for the required contact pressure force. This fixed measure can be determined, e.g., by comparing the rotational speed between the driven and drive elements.

The contact pressure force of the friction wheel can be generated in various ways. Mechanical means, e.g., in the shape of a compression or tension spring are distinguished by low construction expense and high reliability, but are less suited for precise and rapid setting of the contact pressure force.

This disadvantage is avoided in hydraulic and pneumatic systems. They can be used when an existing on-board hydraulic or pneumatic system in the vehicle can be used, in order to achieve loading of the friction wheel depending on needs through the use of a corresponding controller. The on-board pneumatic system can operate using of high or low air pressure. A low-pressure capsule, whose membrane that is connected to a low-pressure source of the internal combustion engine guarantees an exact adjustment of the actuator, is suitable for the low-pressure controller.

An electromagnet that can be excited, for example, in a time-delayed way after the start of the internal combustion engine, in order to activate the friction wheel drive, offers another possibility for adjusting the actuator.

An electric motor offers another way for adjusting the actuator. Here, a combination of the electric motor with a threaded spindle in the form of a ball screw or a roller screw can also be used. The electric motor permits, in an especially simple way, control using an electronic regulator, which is regulated under consideration of the slippage between the driven and drive elements.

The objective of the invention is also met by the independent claim 7. This describes a need-dependent friction wheel drive, which, together with a traction-mechanism drive, forms a drive for auxiliary units of an internal combustion engine. Because the friction wheel, the traction-mechanism drive, and its common driven element are arranged in a plane and have the same width, its axial spatial requirements are limited to their width. The space-saving arrangement of the friction wheel, traction-mechanism drive, and driven element in one plane requires the drive of the friction wheel indirectly via the traction mechanism and not directly via a correspondingly wide contact disk of the crankshaft, on which the traction mechanism and the friction wheel must be arranged one next to the other.

Because the friction wheel is in indirect contact with the contact disk of the crankshaft via the traction mechanism, the contact pressure force of the traction mechanism on the contact disk of the crankshaft is increased by the contact pressure force of the friction wheel and therefore the slippage of the traction mechanism on the contact disk is reduced.

The need-dependent friction wheel drive of the coolant pump allows it to be stopped, which leads to rapid heating of the internal combustion engine during the startup phase of the engine. In contrast to the coolant pump, it is useful that the generator takes in power over the entire operating range of the internal combustion engine.

When the power-steering pump is driven electrically, an elastic belt is sufficient for the sole drive of the generator. This is economical, because it requires no tensioning device. Variants with air-conditioner compressors and/or starter generators require a conventional belt drive with known tensioning systems.

It is advantageous when the friction wheel is in pressure contact both with the contact disk of the coolant pump and also with the loose section of a normal belt, which is used, for example, for driving at least one generator and one air-conditioner compressor. In this case, the friction wheel replaces a belt tensioner for the traction-mechanism drive and is used as a vibration damper for this mechanism.

To achieve the necessary contact pressure force of the friction wheel on the contact disk of the coolant pump and on the loose section of the normal belt, its tensioning motion must be directed against the direction of movement of the loose section.

### BRIEF DESCRIPTION OF THE DRAWINGS

Additional features of the invention emerge from the following description and from the drawings, in which an embodiment of the invention is shown schematically. Shown are:

FIG. 1 a friction wheel drive according to the invention with a friction wheel in connection with a traction-mechanism drive of an internal combustion engine, wherein the loose section of the traction-mechanism drive has a deflection roller;

FIG. 2 the friction wheel drive according to the invention in connection with a traction mechanism drive of an internal combustion engine similar to FIG. 1, wherein the friction wheel is simultaneously the tensioning means for the traction mechanism.

### DETAILED DESCRIPTION OF THE PREFERRED EMBODIMENTS

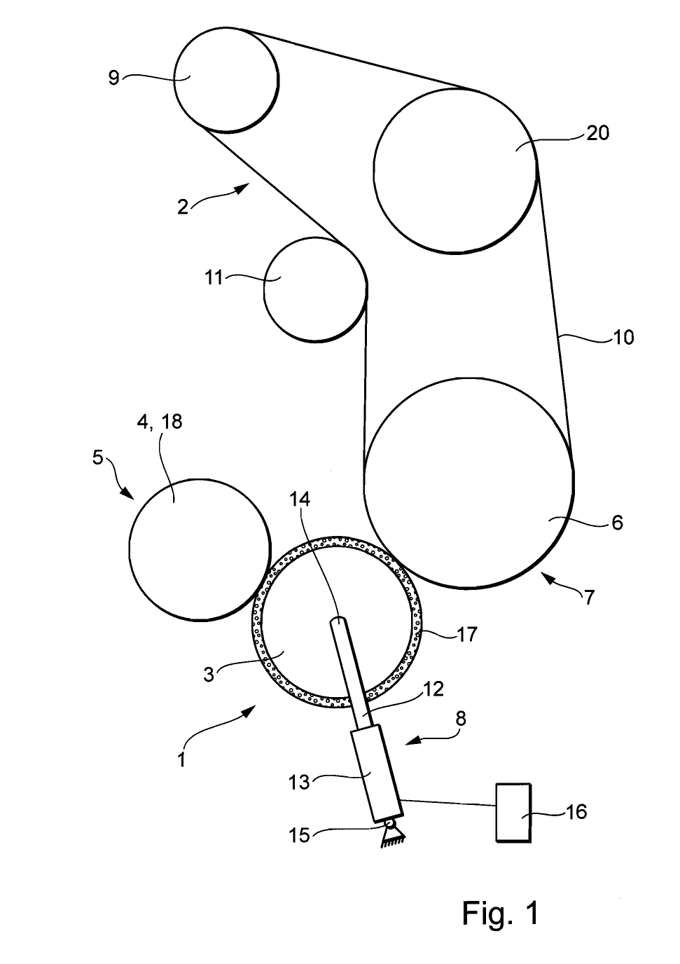

In FIG. 1, a need-dependent friction wheel drive 1 is shown in combination with a traction-mechanism drive 2, which is used for driving various auxiliary units of an internal combustion engine.

The friction wheel drive 1 has a friction wheel 3 with a friction lining 17 for promoting static friction. The friction wheel 3 is in frictionally engaged pressure contact with a contact disk 4 of a drive element 5 of a coolant pump of the internal combustion engine and with a contact disk 6 of a driven element 7 of the crankshaft during the operating period of the engine. The contact pressure force of the friction wheel 3 is directed outwards from an actuator 8. This is constructed as an electrically operated threaded drive, which has a threaded spindle 12 that is continuously adjustable by an electric motor 13. At the free end of the threaded spindle 12 there is a friction wheel bearing 14 for supporting the friction wheel 3 and for the transfer of the contact pressure force to this wheel.

At the free end of the actuator 8 there is a housing-fixed support bearing 15 for supporting the contact pressure force.

The electric motor 13 is conductively connected to a regulator 16. With the help of not-shown sensors, this regulator evaluates the circumferential speed of the contact disks 4 and 6 and calculates from this speed the slippage between the driven element 7 and the drive element 5. The regulator 16 regulates the required minimum contact pressure force of the actuator 8 as a function of the power to be transferred, such that a certain minimum slippage is maintained during the entire operation of the internal combustion engine. Maintaining this minimum contact pressure force for the power to be transferred offers the advantage that the wear and the flexing work of the friction lining 17 are minimized.

The need-based dependency of the friction wheel drive is achieved through a friction-disk coupling 18, which is integrated into the contact disk 4 of the coolant pump. The friction-disk coupling 18 is automatically disengaged at the start of the internal combustion engine and automatically engaged again when a certain coolant and/or lubricant temperature has been reached. In this way, a rapid heating profile of the internal combustion engine is achieved with simultaneously reduced power loss.

The traction-mechanism drive 2 is used for driving auxiliary units of the internal combustion engine, for example, a generator 9 and an air-conditioner compressor 20. For this purpose, a traction mechanism 10 connects all of the associated contact disks or belt disks with the contact disk 6, which is locked in rotation with the crankshaft and which simultaneously forms the driven element 7. In addition, the traction-mechanism drive 2 has a deflection roller 11.

The contact disk 6 wrapped by the traction mechanism 10 and constructed as a belt disk is in only indirect contact with the friction wheel 3 via the traction mechanism 10, while the contact disk 4 of the drive element 5 of the coolant pump is in direct contact with the friction wheel 3 or its friction lining 17.

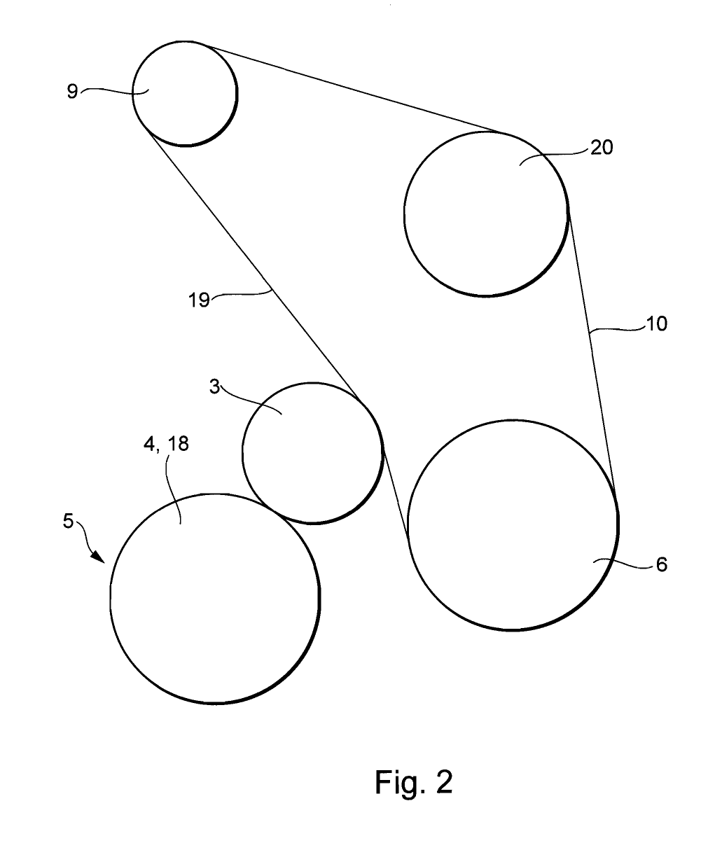

In FIG. 2, a variant of the combined friction wheel/traction-mechanism drive of FIG. 1 is shown. In this case, the friction wheel 3 is also in direct frictionally engaged pressure contact with the contact disk 4 of the coolant pump, with the friction-disk coupling 18 being integrated into the contact disk 4.

At the position of the indirect, frictionally engaged pressure contact of the friction roller 3 shown in FIG. 1 via the traction mechanism 10 to the contact disk 6 of the crankshaft, however, there is instead an exclusive, indirect contact to the loose section 19 of the traction mechanism 10. In this way, the friction wheel 3 takes on the function of a tensioning roller for the traction mechanism 10. This function is realized such that the contact pressure movement of the friction wheel 3 is in the direction opposite the direction of movement of the loose section 19. Therefore, the friction wheel 3 is simultaneously supported on the contact disk 4 of the coolant pump and on the loose section 19 of the traction mechanism 10 constructed as a normal belt for driving the generator 9 and the air-conditioner compressor 20 and tensions this traction mechanism. Therefore, a separate tensioning element is unnecessary.

### REFERENCE SYMBOLS

1 Friction wheel drive
2 Traction-mechanism drive
3 Friction wheel
4 Contact disk (drive element)
5 Drive element
6 Contact disk (driven element)
7 Driven element
8 Actuator
9 Generator
10 Traction mechanism
11 Deflection roller
12 Threaded spindle
13 Electric motor
14 Friction wheel bearing
15 Support bearing
16 Regulator
17 Friction lining
18 Friction-disk coupling
19 Loose section
20 Air-conditioner compressor

1. Friction wheel drive for the frictionally engaged driving of an auxiliary unit of an internal combustion engine, comprising an adjustable friction wheel, which can be brought into pressure contact with at least one contact disk of a drive element and/or a driven element, the friction wheel is in direct pressure contact with the contact disk of the drive element of the auxiliary unit and in indirect and constant, as well as frictionally engaged, pressure contact with the contact disk of the driven element and the auxiliary unit is driven using a switchable coupling, which is used for need-dependent separation of the drive element and the auxiliary unit.

2. Friction wheel drive according to claim 1, wherein the switchable coupling comprises a friction-disk coupling.

3. Friction wheel drive according to claim 2, wherein the friction-disk coupling is integrated into the contact disk of the drive element.

4. Friction wheel drive according to claim 3, wherein an actuator is provided, which is used for applying a contact pressure force, which is required for frictionally engaged transfer of necessary power from the driven element to the drive element, to the friction wheel.

5. Friction wheel drive according to claim 4, wherein a certain level of slippage between the driven element and the drive element is used as a measure for the required contact pressure force.

6. Friction wheel drive according to claim 5, wherein the actuator includes an electric motor with a threaded spindle, which is controlled by an electronic regulator based on the level of slippage measured between the driven element and the drive element, for adjusting the contact pressure force of the friction wheel.

7. Need-dependent friction wheel drive, comprising a friction wheel, which, together with a traction-mechanism drive, provides a frictionally engaged drive for the auxiliary units of an internal combustion engine, the friction wheel drive and the traction-mechanism drive and also a common driven element thereof are arranged in a common plane.

8. Friction wheel drive according to claim 7, wherein the common driven element is a contact disk or belt disk of a crankshaft, which is in direct contact with a traction mechanism and in indirect contact with the friction wheel via the traction mechanism.

9. Friction wheel drive according to claim 8, wherein the friction wheel is used for need-dependent driving of a coolant pump and the traction mechanism is provided for driving at least one generator.

10. Friction wheel drive according to claim 9, wherein the traction mechanism comprises an elastic belt for exclusive driving of the generator.

11. Friction wheel drive according to claim 7, wherein the friction wheel is in direct pressure contact with the drive element of a coolant pump and with a loose section of a traction mechanism comprising a normal belt.

12. Friction wheel drive according to claim 11, wherein the contact pressure movement of the friction wheel is in a direction opposite a direction of movement of the loose section.
